(19) United States
(12) Patent Application Publication
(10) Pub. No.: US 2010/0131328 A1
(43) Pub. Date: May 27, 2010

(54) Method and System of Promoting Alternate Dispute Resolution

(76) Inventors: David S. DeLugas, Marietta, GA (US); David P. Scitthelm, Atlanta, GA (US); Steven J. Campbell, Simpsonville, KY (US)

Correspondence Address: Woodcock Washburn LLP, 2929 Arch Street, Philadelphia, PA, 19104, US

(21) Appl. No.: 12/580,243

(22) Filed: Oct. 15, 2009

(51) Int. Cl. G06Q 99/00; G06Q 20/00; G06F 3/048; G06Q 10/00

(52) U.S. Cl. 705/9; 705/309; 705/40; 715/780; 715/760

(57) ABSTRACT

A method and system of performing an alternate dispute resolution procedure by: providing an alternate dispute entity that is a scheduling service, facilitator and provider of mediation and/or arbitration services. An inviter asks the entity to initiate a mediation or arbitration procedure with an opposing party who has not been informed by the inviter of his/her decision to mediate or arbitrate. The entity extends an invitation to mediate or arbitrator to the opposing party. If the invitee accepts the invitation, the entity selects a mediator from a pool of mediators; and conducts the mediation via webcam on the entities website or at a location selected by said inviter and invitee.

### BACKGROUND OF THE INVENTION

1. Field of the Invention

This invention relates generally to alternative dispute resolution. More particularly, the present invention is a system and method for one party in a dispute to invite the other party in the dispute to resolve their issues by mediation rather than through litigation in a court of law which involves a lawyer on each side and the relatively high costs that are associated with the law suit.

2. Description of Related Art

Alternative dispute resolution (ADR) is a very useful, cost-effective method for settling a dispute between two or more parties. The alternative to ADR is litigation in the courts of the United States which can be very expensive and time consuming. ADR offers the opportunity for individuals to meet, usually through mediation, where an impartial mediator works toward recommending a non-binding solution to the problem that is acceptable to both sides. The mediator may or may not listen to evidence and does not have authority to impose a solution. Mediation differs from another form of ADR which is known as arbitration where an arbitrator hears evidence, much like a judge, and decides on a specific solution for the individuals wherein the solution can be binding on both of the parties.

Mediators in private practice get most of their work through referrals, either through the lawyers handling a case or the court system where some states have mandatory mediation programs. Some disputes not in the legal system are resolved through formal (fee based) mediation. On the other hand, many disputes are addressed and resolved through mediation in the form of intervention or mediation by a mentor, supervisor, pastor or minister, community leader, or governmental agent.

In the engagement of a mediator for a fee, other than by referrals, less formal sources are relied upon such as industry colleagues, therapists, mediation committees, word of mouth, and personal advertising. In each of these instances, private practice mediators need the mutual consent of the parties involved to first seek mediation as the chosen method to resolve an issue. Then the mediator's services are sought out based on the mediator's efforts through referrals, experience, area of expertise and media recognition.

The current approach to Mediation is very “reactive”. The parties to a dispute who are unable to agree on the resolution of their dispute, to participate in mediation, must first agree to mediate, then agree on who will serve as the impartial mediator, in an atmosphere almost always marked with distrust of one another, and then agree on the venue, date and time. Thus, mediation itself faces numerous hurdles to being employed as a dispute resolution device. Due to these hurdles and barriers, the market comprised of disputing parties often opts to do nothing about an issue. The perceived expense and/or time involved in mediation coupled with the misbelief that the only viable option is to hire an attorney and engage in litigation, further makes the current mediation system disadvantageous. Often times, only when asked by the court system, the lawyers, or a third party recommendation, is mediation considered.

Mediation, by definition, requires the consent of both parties. Without consent, the default option, litigation, will be used. Without the ability of one party to “summons” the other party to resolve an issue using mediation, mediation is not considered as the first option of dispute resolution and, therefore, will always be relegated to limited exposure, understanding, and, thus, utilization.

### SUMMARY OF THE INVENTION

The key enhancement of an ADR provider entity system here disclosed is that the party (“Invitor”) who has made the decision that a dispute (real or perceived) worthy of action may do so without directly contacting the adverse party (as would be the case when filing a lawsuit) and yet employ the favored and effective method of mediation in the most economical and expeditious manner possible. An ADR provider entity contacts the adverse parties, extends the invitation to mediate or arbitrate, educates the Invitees on the merits of mediation or arbitration (binding or non-binding) and, significantly, of the good faith of the party initiating the process who has made a tangible commitment in the form that party's pre-payment of his/her share of the mediator's fee. When the mediation of a dispute is accepted by the Invitee, the participants will be confident in the process of mediation or arbitration; more specifically, in the neutrality and confidentiality imbedded in these processes and in the good faith of the opposing party as tangibly demonstrated by the pre-payment of the equal share of the mediator/arbitrator fee and in the prospect of a “Win-Win” resolution within an approximately Five-week time parameter of the ADR provider entity method.

By offering the ability to contact the other party to address a dispute through an “invitation to mediate”, the ADR provider entity brings mediation to the market as a first line option. The mediation “invitation” creates the ability to initiate a solution without having to initiate the legal system and, importantly to the psyche of the initiating party, without having to directly contact the party with whom he/she has a dispute or problem. It allows people to send an invitation instead of a summons, which often escalates the stakes and the dispute ultimately leading to a time-consuming process of litigation. The ADR system is a proactive tool that leads parties to mediation without being ordered by a court to do so (which requires there to be a lawsuit) and, if no lawsuit has been filed or would be filed due to the nature or size of the dispute, without having to contact and get the other party's agreement to mediate. Rather, the invitation tool on its own opens the way for new ground to be laid in dispute resolution with mediation becoming the first option because of its appeal and ease of employment through the ADR method herein disclosed. This system is then a tool that offers the best alternative to how a person or business addresses an issue by allowing a resolution discussion (mediation) to be scheduled rather than the more commonly employed choices of “do nothing” or go to war through the legal (in)justice system.

There is disclosed a method and system of performing an alternate dispute resolution procedure by: providing an alternate dispute entity that is a scheduling service, facilitator and provider of mediation and/or arbitration services. An inviter asks the entity to initiate a mediation or arbitration procedure with an opposing party who has not been informed by the inviter of his/her decision to mediate or arbitrate. The entity extends an invitation to mediate or arbitrator to the opposing party. If the invitee accepts the invitation, the entity selects a mediator from a pool of mediators; and conducts the mediation via webcam on the entities website or at a location selected by said inviter and invitee.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of an ADR process in accordance with the principles of the invention;

FIG. 2 is an additional flow diagram an ADR process in accordance with the principles of the invention; and

FIG. 3 is a timeline of an ADR process in accordance with the principles of the invention.

### DESCRIPTION OF THE PREFERRED EMBODIMENT

A system and method for providing a scheduling service, facilitator and provider of Mediation and Arbitration services to market sectors including small and large businesses, community organizations, court systems, and individuals for consumer, divorce, personal, and work issues is disclosed.

Mediation (currently often referred to as an “Alternative Dispute Resolution” hereinafter “ADR”) is internationally accepted for its ability to bring two or more disputing parties to an agreement that resolves the dispute(s). Mediation is conducted with a “Mediator,” who is a neutral party, trained and skilled in techniques and methods that open and improve dialogue between disputing parties, facilitating the parties in reaching an agreement which each may view differently, but which has the same impact; i.e., ending the dispute.

Arbitration is another form of ADR, which is a private trial conducted by an “Arbitrator,” a neutral person trained in the conduct of such private trials. The arbitration ends with a decision by the Arbitrator. The parties decide in advance the authority of the Arbitrator and the scope of his decision and, significantly, whether the decision will be binding (final) or non-binding. (advisory, so as to provide some objectivity to further negotiations perhaps in mediation).

With less than 5% of the world's population the USA has over 70% of the world's attorneys. Nearly 90 million lawsuits are filed each year in the USA, ranking the USA #1 in the world in formally asserted claims.

The legal system has limits on what it can and cannot do because the laws and procedures applicable to a particular subject dictate the range of outcomes. The legal system is also burdened by the high cost of attorneys and other expenses of litigation such as expert witnesses, court reporters, document production and the time, productivity and personal well-being of the participants. Added to the cost of the legal system is the spiraling costs of the governmental system (the judicial system with its buildings, infrastructure, staffing, and security costs) and the lengthy backlogs as the volume of cases always outpaces legislative allocations to the judicial system. The judicial system is founded in history and the notion that seeking the truth comes best when adversaries present evidence and make arguments. What matters is ending the dispute in a fair, expeditious, and economical manner, benefiting the warring parties and society as a whole.

In the judicial system, litigation is a process whereby each party presents its case and a judge or jury decides what the facts are, applies the applicable law and, thus, decides the outcome, almost always by awarding, or not awarding a certain sum in compensation, and providing no other relief or decision as limited by law, and does so by making one party right and one party wrong or, as often is the case, neither party is right and neither party is wrong and no one feels any level of satisfaction or finality.

Contrast then, mediation. By design, mediation is an endeavor in which each party to a dispute seeks the outcome they desire, recognizing that that outcome can only be achieved through an agreement being reached. Thus, each party is motivated to find and to craft the unique terms that will be acceptable to all; in other words, for a party to win, they have to be willing to allow the other parties also to win, which is not an absolute outcome, but a perceived outcome. As a result, mediation is an endeavor of all parties.

Mediation is a process which is, by definition, voluntary. The participants must always be in control of the final outcome (agreement or no agreement). Among many differentiating qualities of mediation is the freedom to ignore what the possible outcomes at trial might have been based upon the applicable laws and to permit the construction, design and implementation of an agreement that simply satisfies each of the parties. In other words, a dispute that may have started as being purely financial may be resolved by an agreement that includes an apology, future business dealings to the benefit of all, and implementation of new policies or procedures, terms that the judicial system almost always unable to dictate.

By mediation, the disputes are addressed by negotiating, not what can I make you do, but, what are you willing to do and what do you want or need from me in return. Such a collaborative approach, with the active participation of the mediator guiding the process, minimizing the conflict, and focusing the parties on the end game, not on the distraction of who is right or wrong, leads to a quick resolution, one that can be unique and tailored to the parties to the dispute. Mediation also offers confidentiality, the certainty that, if there is an agreement (an outcome) it will be, by definition, acceptable, significantly lower costs in fees and other legal expenses, considerable savings of time, emotional venting and decreased emotional toll, an informal atmosphere (comfort level) and considerably greater convenience whether conducted by webcam, teleconference, or in person. Mediation provides resolutions by parties coming to an agreement and not, as happens within the judicial system, by a party being declared the loser.

Participants in mediation report higher satisfaction rates than people who use the legal system. Because of their active involvement in designing the agreement, parties to a mediated agreement are far more likely to comply with the agreement than losing parties in litigation who have a verdict from a jury or judge, which requires the winning party to employ post-judgment legal processes to collect or to force compliance.

Mediations end in agreements 70 to 80% of the time and have high rates of compliance.

Notably, less than 5 percent of cases initiated in the legal system actually go to trial! Because 95% (approx 85 million per year) of all cases filed in the judicial system do not go to trial for a decision that determines the outcome, then utilizing a mechanism or method other than the judicial system to get to a final resolution, particularly when the final outcome can be reached by agreement far more expeditiously and more cost effectively than through litigation!

One attribute of litigation that must be attractive to the initiating party (the Plaintiff) is that, by filing a complaint, a summons is issued and served upon the opposing parties (the Defendants) and those opposing parties are then required to respond, usually within 30 days. By forcing a response (the failure to respond timely being an adverse judgment by the Court), the initiating party is assured of making the opponent recognize him by the complaint or issue being raised. Yet, even with the power of the judicial system that comes from governmental authority, 95% never go to trial. This fact begs the question then; why engage the judicial system when doing so is so costly, delays resolution for months, if not years, based upon procedural rules, and increases and heightens, not soothes, the business or personal relationships of the parties?

Utilization of the legal system far outnumbers utilization of mediation services. Reasonable explanations include:
A lack of knowledge regarding mediation.
Attorneys as gatekeepers to mediation, who avoid mediation before filing suit or delay mediation until a trial is near for various reasons.
The mediation market remains small because using mediation, unless court-mandated, requires consent of both parties. Without consent, the default option, litigation, will be used.

The system and method herein disclosed is directed to changing how disputes are addressed and, in most cases, resolved!

There is provided a system and method for a business or individual to contact, to alert, to engage or to “summons” the other party by sending an internet-based, online “Invitation” to solve the perceived or actual dispute through Mediation (or Arbitration). Inviting the other party, through an ADR provider entity, to “sit down and talk” about whatever problem or dispute the initiating party has with the other party (or believes the other party has with the initiating party) is an arms length, safe, simple, efficient, expeditious and economical means to seek a resolution that can be a “win-win” and to do so without entering the judicial system.

By providing the “Invitation” as a “first contact” for dispute resolution, all parties can save the extra steps and related time and expenses associated with the judicial system. Not to be overlooked, as it is an integral aspect of the service provided by the ADR provider entity, is the collection of a non-refundable invitation fee as well as a refundable deposit of one-half (½) of the mediator's fee. By doing so, the invitation will communicate the good-faith desire of the initiating party to arrive at an agreement and, thereby, encourage the invitee to accept the invitation, pay the other one-half (½) of the mediator's fee, finalize the scheduling of the session, and participate in good-faith in an effort to find the “win-win” resolution that is unavailable in litigation.

Empowered with the ability to initiate an invitation to mediate or to arbitrate problems and disputes (of any nature or character, even those not usually addressed by the judicial system), businesses and individuals may avoid the uncertainty, delay, cost and the enormous personal commitment of litigation.

By utilizing technology, the ADR provider entity provides mediation and arbitration services beginning with the invitation and including real-time scheduling, web cam video-conferencing and in-person sessions mornings, afternoons, and evenings seven (7) days each week. By offering these unique bundled services via the Internet, the ADR provider entity can attract users worldwide. To deliver the mediation services (distinguished from the invitation, scheduling and payment aspects), ADR provider entity will have collected an international roster of Mediation Professionals with diverse areas of expertise and multi-language abilities.

### What is the Current Procedure?

Mediators in private practice get most of their work through referrals, either through the lawyers handling a case or the court system where some states have mandatory mediation programs. Few disputes not in the legal system are resolved through formal (fee based) mediation. On the other hand, many disputes are addressed and resolved through mediation in the form of intervention or mediation by a mentor, supervisor, pastor or minister, community leader, or governmental agent.

But when it comes to mediators getting retained to mediate for a fee, other than referrals, less formal sources include industry colleagues, therapists, mediation committees, word of mouth and personal advertising. In all of these instances, private practice mediators need mutual consent of the parties involved (forced by the court system or otherwise) to first seek mediation as the chosen method to try to resolve an issue, then the mediator's services are sought out based on the mediator's efforts through referrals, experience, area of expertise and media recognition.

Mediation has not been presented as a first option to resolving a dispute. The current readily accepted choices when handling a problem or dispute is to do nothing or to litigate. Only after parties are engrossed in litigation do they often realize the consequences of this course of action and “alternatives” are considered. However once in the legal system, the attorneys, the court systems, and the litigants, directly or indirectly encourage staying the course of litigation only until close to trial and the possible adverse outcome pressures the parties or the court rules require the parties to mediate. Although cases in litigation most often do settle when mediated, mediation at the later stages of litigation are burdened by the costs and other resources consumed during litigation that are considered for recoupment from the other party, by the emotions that have been fueled, and by the combatant's attitude that has grown during the legal process.

The method in which mediation is first chosen by the parties as the resolution medium is hampered by the conflict itself where inherently the parties may not want to communicate directly with each other, trust each other, and tend to not agree that a problem exists or how best to resolve it. This is why an attorney or a court order, not the individuals themselves, currently initiate the vast number of mediations.

When parties do seek an early mediation of a problem or dispute, the other party is suspect of the mediator nominated by the first party simply because that party nominated the mediator. Even picking the venue and the date and time are areas for disagreement, thus hindering mediation being held.

As there is not one source or standard for evaluating a mediator, the task of choosing the appropriate one is made more difficult. If the parties are conducting this task, they are left to their own to research and then evaluate each individual as to his skills, experience and suitability to the problem or dispute to be mediated. If the judicial system is intervening, there exists in many states a certification program instituted by the judicial system, and a roster of available mediators that meet this criterion to help facilitate the selection process. Yet, there is a lack of information as to qualifications even while there is an abundance of self-promotion by mediators and self-formed mediation associations and organizations, membership in which is attained through the payment of dues and, in some cases, acceptance by the organization using arbitrary qualifications such as recommendations by existing members, none of which reveals true skills and abilities.

Scheduling and the facilitation of mediation currently are labor-intensive processes. Many phone calls and other communications are required to find, agree upon and retain the selected mediator, an appropriate date and time, and location or means to conduct the mediation. Mediation then is to take place with the parties and the mediator meeting at a location that may or may not be convenient to any or all of them. With companies and individuals who have disputes including everyone on the planet, those who would seek to resolve a problem or dispute through mediation will most often not be in the same area of a city or even in the same city, state or country requiring either inconvenient and annoying travel across town or expensive and time consuming travel across a state, country or internationally. Depending on the nature of the problem or dispute and the importance to the parties to resolve it, these factors may result in mediation not being pursued at all, yet the problem or dispute remains.

When mediation is initiated by an attorney of record in an existing action or by an ADR provider entity that is part of a court system, the assistance provided to select the mediator and to schedule the mediation ranges from not at all to highly inefficient telephone and U.S. Mail efforts, with no single source or sophisticated software based automated (or near automated) system. As a result of these inefficiencies, merely scheduling a court annexed mediation is difficult, time consuming, discouraging, and, significantly, conflict generating as the attorneys and parties to the mediation have an opportunity to disagree about the venue, the mediator, the date, the starting time, the cost, the split of the fees, and the pre-mediation consideration by the mediator of briefs, letter, documents or other information attorneys often wish to provide so as to “get the mediator” on his client's side. The opportunity for increased conflict coming just from the scheduling of mediation and selection of the mediator is increased geometrically when more than two disputing parties are involved and, often, disputes involved more than two parties with some types of disputes necessarily involving a multitude of parties. The logistics involved in resolving the scheduling issues often predisposes the mediation to impasse rather than agreement.

By generating conflict, the coordination and scheduling by the parties or their counsel or by administrators associated with court systems often make reaching an agreement difficult by altering negatively the attitude of the parties and their counsel toward the other party and counsel and raise concerns about the neutrality of the mediator. The parties and counsel will appear, as they are under a court order to do so in those court systems that either always require mediation or where a motion is granted requiring mediation. The cost and burden to the court system to maintain such a scheduling system is, of course, passed along to the parties to law suits through increased fees or to the tax payers who fund the court systems.

Currently, in-person mediation is the norm and mediation sessions are most often held in conference rooms located within a judicial complex, a space allocated for that purpose, adding to the costs to the taxpayers, or in conference rooms at the offices of one of the attorneys or the mediator. In few cases, mediation is conducted by telephone or video-conference with documents being circulated by facsimile or email in advance. In such mediation sessions held remotely, the logistical arrangements provide yet one more opportunity for conflict even before the parties undertake to mediate the dispute or problem that necessitated logistical coordination.

When not ordered by a court system to mediate, current awareness and current access to mediation is limited, rendering mediation (1) as an afterthought to litigation, if considered at all before litigation is initiated, and (2) litigation takes on a life of its own without mediation being employed to stop litigation. Access to mediators is not at all limited, as mediators have web sites and market themselves to the public and to attorneys. Yet, mediators currently have not successfully made themselves available to parties and legal counsel without having such contact taint their neutrality as perceived by an opposing party or counsel who then is reluctant to utilize that mediator first contacted by the opposing party in a manner that may have influenced the mediator. While mediators are supposed to be neutral and, consciously at least, are most certainly neutral regardless of the contact with a party before mediation begins, it is the perception by any party or legal counsel that so strongly affects the willingness of a party or his counsel to use that mediator or, if used, to engage in the mediation process openly so as to make reaching an agreement possible.

The entire process of mediation education, selection, accreditation and the process by which it is conducted is a fragmented, unstructured, lacks a single source and requires a very labor intensive effort with multiple communications to accomplish such as voice mails to return, written confirmation via postal service, and difficulty in rescheduling or canceling on short notice.

### What are the Deficiencies in the Current Procedure?

As mediation does not have any recognized and reputable source for education as to the benefits of this method of dispute resolution and ways of attaining the required assistance, the market, which is the disputing parties, by far opts to do nothing about an issue due to the perceived expense and/or time involved in litigating the dispute, which is viewed incorrectly as the only option to litigate or do nothing. This causes a belief that the only viable option (to doing nothing about the problem or dispute) is to hire an attorney and engage in litigation within the legal system where inherently the parties are encouraged to continue to utilize this system. In some instances and some disputes, access to the legal system without the necessity of attorneys is permitted. But in those instances, pro se parties most often are left unsatisfied due to uncertainty, consumption of time in traveling to and appearing at court hearings consuming full days for short hearings or even for continuances and rescheduling, and the difficulty of enforcing any judgment or order that may be entered.

Only when asked by the court system, the lawyers, who would normally be interested in keeping the business for themselves, or a third party recommendation, is mediation considered. Mediation, by definition, requires the consent of both parties. Without consent, the default option, litigation, will be used. Without the ability of one party to “summons” or call upon the other party to resolve an issue using mediation, mediation is not considered as the first option of dispute resolution and, therefore, will always be relegated to limited exposure, understanding, and, thus, utilization.

Private demand for mediation has been underwhelming, because, in addition to ignorance, people remain leery of making the first overture to conciliation or compromise or are not confident that negotiation will lead to the settlement of disputes. After all, the conflict or dispute has manifested in some manner so that a party is aware, all too keenly aware in many instances, that the dispute is real and that the other party is stubborn, unreasonable and not interested in a solution. Some mediators have suggested that the relatively low usage of mediation results from the fact that people do not know about mediation or how it could be used to solve their disputes. Others retort that demand for mediation has been flagging because the marketing message for mediation has been ineffective. Mediators do not offer clients what they are looking for: a process where the prerequisite is not to be trusting, reasonable or logical, but is a process where they can be angry and resentful, yet one that works and one where they will not be exploited. In a survey of New Jersey residents, only two out of 400 respondents mentioned mediation as a possible means of resolving disputes, and neither spoke positively about it. The study suggests that American citizens are committed to litigation and “are not anxious to give up courts for mediation” due to misinformation, ignorance, lack of confidence and lack of easy and affordable accessibility.

As stated, above, the current approach to Mediation is a very “reactive” one. The parties to a dispute who are unable to agree on the resolution of their dispute, to participate in mediation, must first agree to mediate, then agree on who would serve as the mediator (in an atmosphere almost always marked with distrust of one another, and then agree on the venue, date and time.) Thus, mediation itself faces numerous hurdles to being employed as a dispute resolution device.

Mediation currently lacks the process by which a party addresses a dispute proactively by initiating a claim, extending an option to resolve the issue, and demonstrating good faith both by expressing an interest in mediation, by spending money to invite the other party to mediate, and by depositing one-half of the mediator's flat fee as part of the overture or invitation to mediate. Without the ability to “summons” the other party to resolve the dispute, mediation is left to disputing parties to be agreeable to this solution of resolution, which is typically not the inclination of the parties involved, nor the judicial system that serves the parties.

Choosing a prospective mediator is a complex issue in that there is not one set of credentials that mediators follow. With different areas of expertise, different standards or accreditations, and the options varying from a sole part-time practitioner, to small groups of mediators in joint practice, there is a lack of uniformity, standardization and ability to compare these resources on a level playing field. Even among those groups that tout themselves as self-regulating or as being particularly qualified for one reason or another, those qualifications are most often self-granted or are unrelated to the true skills and abilities of the mediator in practice. As an example, former judges mediate to generate income in retirement, yet, having been decision makers as judges, judges are regarded among those with knowledge of the industry as all too often poor mediators. Mediators are to allow the parties to formulate their agreement voluntarily where each side can believe he or she is right. Judges are trained and are used to making decisions and telling parties what they will do. As is true in many professions, a good reputation does not necessarily mean one is a good mediator. Mediation requires skill and training, no doubt, but mediation is also an art and one that requires great flexibility and adaptability on the fly. As a consequence, the parties to lawsuits, legal counsel and the public (not involved in a lawsuit) have little to go on in accessing which mediator could best work with the disputing parties and guide them to and facilitate an agreement between or among them.

When mediations are initiated at the request of the court and legal system, there are departments within the court system that are dedicated to assigning a mediator to the dispute, assigning the venue and arranging a scheduled time to meet. In most jurisdictions, the “assignment” of a mediator is done by random assignment, assignment by rotation (who is next on the list), or by favoritism with the administrative staff doing the assigning.

Travel costs, inconvenience, aggravation and the amount of time involved are increased and add to the burden of warring parties when parties live or work in locations not near one another or far from the location of the judicial complex where the ADR offices have conference rooms, the offices of the attorney or mediator whose conference room is to be used. Of course, this is also true in litigation as courthouses rarely are convenient to parties and never easy to access where parking and security alone are often problems or consume more time.

### Why is an ADR Provider Entity Different?

The key enhancement of an ADR provider entity is that the party (“Inviter”) who has made the decision that a dispute, real or perceived, is worthy of action may do so without directly contacting the adverse party, as would be the case when filing a lawsuit and yet employ the favored and effective method of mediation in the most economical and expeditious manner possible.

Educating the market place of a means and mechanism to mediate and, of course, the benefits of mediation, so as to change the tipping point in favor of mediation/arbitration over either doing nothing or litigating will be a focal point of the marketing effort of the ADR provider entity. The system requires the initiating party (a) to pay a non-refundable modest fee in order to have the ADR provider entity contact the adverse parties, (b) to deposit a refundable fee equivalent to one-half (½) of the standard mediation fee, (c) to provide contact information for the opposing party, (d) to identify from a drop down list the nature or area of the dispute to be mediated or to be subject to arbitration (binding or non-binding), and (e) to mark a real-time calendar for the two (2) week period of time that begins two (2) weeks hence and to commit to a minimum of fifteen (15) sessions from among the forty-two (42) sessions available (morning, afternoon and evening, local time for the initiating party, seven days each week for that two week period).

The ADR provider entity contacts the opposing parties, extends the invitation to mediate or arbitrate, educates the Invitees of the merits of mediation or arbitration (binding or non-binding), and, significantly, of the good faith of the party initiating the process who has made a tangible commitment in the form that party's pre-payment of his share of the mediator's fee and allocation of time to sit down and talk about the problem or dispute. When the mediation or arbitration of a dispute is accepted by the Invitee, the participants in the system will be confident in the process of mediation or arbitration, in the neutrality and confidentiality imbedded in these processes and in the good faith of the opposing party as tangibly demonstrated by the pre-payment of the equal share of the mediator/arbitrator fee, the commitment to the time and date of mediation or arbitration, and in the prospect of a “Win-Win” resolution within the preferred five-week time parameters of the system.

The ADR provider entity will have an online system in place where one party can “summons” or initiate the request to mediate a dispute by contacting the other party through the ADR provider entity which will be regarded as neutral, professional, honest, and incapable of favoritism or bias. The invitation from ADR provider entity is the way to initiate mediation or arbitration as a resolution process without creating an atmosphere of bias by one of the parties having already contacted the mediator who will mediate the dispute as the automated process omits all contact with mediator until the mediation is assigned and the mediation begins as scheduled.

The ADR provider entity is a third party neutral where an invitation to mediate can be initiated by any party, whether the party who feels wronged or who is concerned about another party believes that party has committed an offense or wrong against the other. Through the ADR provider entity, the invitation to mediate will be sent without a mediator having any contact with either party as the mediator is not part of the invitation process. The ADR provider entity will hold itself as truly neutral in this process giving confidence to both parties of a neutral and well-qualified mediator being assigned to their dispute or problem, giving confidence in the process and eliminating the potential for disagreement as to the mediator. Because the mediation or arbitration will be held virtually via web cam or video conference, the potential for disagreement as to venue (and the hassles of travel) are eliminated. The scheduling of mediation or arbitration becomes fluid as the initiating party must offer no fewer than 15 morning, afternoon or evening sessions over a two week span, virtually assuring the recipient-invitee of dates and times that suits him.

The process to collect and send information from the initiating party of the ADR provider entity “invitation to mediate” is done through the ADR provider entity website. The recipient of the invitation will become aware of the initiating party's perception that there is a problem or dispute that justifies the initiating party doing something and litigation, at the moment is not the choice, but it can be pursued if an agreement is not reached at mediation or after non-binding arbitration, the nature or subject of the dispute or problem, but not the specifics, the proposed offer to mediate the dispute or problem, and the determination and good-faith of the initiating party. Then, the recipient, the invitee, must decide whether to accept the invitation and join in the process toward a win-win resolution or reject the invitation and be subject to legal action or the ramifications of leaving the problem or dispute unresolved.

The process will allow the inviter to demonstrate the intent to resolve the issue by sending a brief description of the complaint to the invited party, provide verification of good faith by the deposit towards payment of a mediation session and the non-refundable payment of the $75 invitation fee.

Declining or accepting the invitation, the scheduling of when the accepted mediation or arbitration will take place, the venue, offering video conferencing as an option, and the mediation or arbitration session, the agreement or impasse and the follow-up will be handled online through various technology with the ADR provider entity website invitations, scheduling tools, video conferencing and email tools.

The ADR provider entity will give alternatives and flexibility as compared to the traditional forms of addressing problems and disputes. By offering sessions outside of business hours and weekends, being able to conduct the entire invitation, mediation and agreement and client survey process online. Multi language skills, subject matter expertise, capped costs, quick scheduling and holding of the sessions, and all parties expressing a good faith desire, not court imposed, to seek a resolution are all within the method and bode well for an efficient, effective, and cost-contained process that will derive participant satisfaction even if an agreement is not reached.

Parties with adequate internet access and now ubiquitous webcam hardware or hardware supplied by the ADR provider entity as an up charge will not be required to travel to a physical location, meet the other parties in person, have security issues associated with being in-person, get caught in traffic or parking issues, be seen by the public and media, be concerned with attire, or consume time which must be allocated to other endeavors or interests. Parties not in the same part of a metropolitan area, or not in a metro area at all, but at a distance from one another, now may address problems and disputes that would not otherwise justify the time, expense and inconvenience of travel or, even if justifiable to do so, may mediate or arbitrate without adding the recovery of travel costs to the terms of the agreement in order to reach that agreement.

The result of the mediation, when done online, will be captured in an electronic agreement by the parties. The parties will use electronic signature to make the agreement binding and the agreement as affirmed by the parties will be archived on AV electronically and available to the parties if necessary, and an additional fee applies. When done in a face-to-face meeting, the agreement will be signed and distributed at the end of the mediation session.

How does it Solve the Deficiency?

The ADR provider entity's business methodology offers for the first time, the ability to address a dispute employing an invitation to resolve an issue, without requiring the legal system, although the ADR provider entity will be suitable and can be utilized by court systems seeking to save money and to improve efficiency. By offering to contact the other party to address a dispute through an “invitation to mediate”, the ADR provider entity brings, for the first time, mediation to the market as a first line option.

The mediation “invitation” creates the ability to initiate a controlled and assisted negotiation without having to engage the legal system and, importantly to the psyche of the initiating party, without having directly to contact the party with whom he/she has a dispute or problem, or whom he/she believes has a dispute or problem with him or her. It allows people to send an invitation instead of a legal summons, which summons often escalates the stakes and the dispute ultimately leading to a time-consuming, dollar wasting, and ineffective process of litigation where “lose-lose” is the most common outcome.

The method is a proactive tool that leads parties to mediation without being ordered by a court to do so, which requires there to be a lawsuit and, if no lawsuit has been filed or would be filed due to the nature or size of the dispute, without having directly to contact and get the other party's agreement to mediate, then agree on the mediator, the date, time, and location as addressed herein. Rather, the invitation tool on its own opens the way for new ground to be laid in dispute resolution with mediation becoming the first option because of its appeal and ease of employment through the ADR provider entity and the enhanced likelihood of an agreement being reached because of the attitude adjustment that comes from both parties being witness to the good faith of the other party by the deposit of one-half (½) of the mediator's fee and voluntarily committing to the mediation.

This system is then a tool that offers the best alternative to how a person or business addresses an issue by allowing a resolution discussion (mediation) to be scheduled rather than the more commonly employed choices of “do nothing” or go to war through the legal system.

By creating these tools as an online resource, people can now source a mediator without directly contacting the mediator or firm. The selection process of who the mediator is happens after the invitation is accepted and is handled by the ADR provider entity without input from any party to the dispute; therefore, this process will not be suspect of bias.

The invitation system allows a party to communicate indirectly with the other party and gives a means to do so where others might not exist or are foreboding or difficult. This invitation on its own may be enough to address an issue and initiate a resolution, however the good faith effort of depositing one-half of the cost for the mediation demonstrates both the desire to find a resolution and the severity of the problem or dispute that warrants this payment.

The online calendar will allow parties quickly to agree on a date and time for the session, and for court ordered mediations, the ADR provider entity calendar system will help in the coordination of available mediators and the parties' schedules without the need for extensive telephone and postal service written communications.

Conducting the mediation via webcam on the ADR provider entity's website, parties now do not need to travel for the mediation session. This avoids face-to-face contact when not desired, makes the process more convenient, accessible, confidential, affordable, efficient, and likely to produce an agreement.

As the mediators are not required to be local, (in the case of an online session) the ADR provider entity will have a pool of subscribing mediators on the roster, these resources will be categorized according to specialty, availability for the sessions schedule, ability to be multilingual as needed and experience.

The ADR provider entity will create its own Mediation training course, a passing grade is required by all mediators prior to facilitating resolutions for the ADR provider entity. A national campaign by the ADR provider entity will allow mediators from across the country and internationally to gain this certification and create a standard by which people can benchmark performance and competency of the acting mediator.

### Details:

Educating businesses and individuals of the benefits of mediation, the system would employ a web site at which the Inviter pays a nominal non-refundable fee ($75.00) and deposits a refundable $500.00 mediation fee representing one-half (½) of the mediator's fee for a fixed period of time (currently viewed as 3½ or 4 hours), which then causes the system to send an “invitation” to the Inviter's opponent describing the general nature of the dispute or problem; e.g. money owed, neighbors with a property line dispute, family personal issue, business dispute, employee-employer problem, construction site issues, small claims (but large enough financially or emotionally to justify the $500 per side mediation fee), vendor-manufacturer problems, customer complaints, and even significant disputes, claims or problems that currently become court cases without consideration of early resolution through mediation or non-binding arbitration.

The invitation explains mediation (an alternative to a lawsuit where through lawyers in a courtroom a judge or jury decides a persons fate/outcome in about 6 months up to a couple years at a cost of $1,000 to $25,000 (average) to $100,000 or more depending on the nature and size of the dispute), the timetable of within five weeks (preferably not sooner than 3 weeks nor preferably longer than 5 weeks from initiation) for a resolution to be achieved (as soon as the parties convene and, with the assistance of a mediator, discuss and work out an agreement that can be more than a “I win, you lose” but most likely “we both win a little and lose a little”), and the neutrality of the professional mediator (who is there to facilitate the discussion and negotiations and to guide the parties toward a final resolution). If the recipient of the invitation (“Invitee”) to mediate agrees to do so, then the Invitee goes to the web site and deposits the $500 mediation fee and the mediation is scheduled based upon the calendar of available sessions offered by the Inviter over the ensuing 2 weeks (thus, expediency is another benefit of the method).

Unlike traditional professional services, mediation sessions would be scheduled 3 times each day (morning, afternoon and evening) seven days each week. Why? Because depending on one's schedule, Monday through Friday 9 to 5, traditional court times, just aren't convenient and, therefore, increases costs, financially and otherwise (note how this further distinguishes this process from the judicial system). Parties to a dispute will feel less put out and will be more receptive to crafting resolutions when the mediation is held when it does not require time off from work or away from their business. Excellent mediators will work evenings and on Saturdays and Sundays when being paid $150 per hour. With the use of web cameras, video conferencing, convenience is more than just a passing thought. No traffic or travel concerns (parking), security at courthouses or in airports no longer detract from the process, access to files and to personnel who might get involved in crafting the resolution is possible, and a positive atmosphere brings “win-win” to the table. With the use of translators and multi-lingual mediators, from the outset, addressing and resolving disputes between and among those whose language and cultural barriers might have contributed to the dispute becomes not only appealing, but necessary.

The ADR provider entity, through a marketing campaign consisting of social media, email contact and website will drive awareness of the value of mediation.

The ADR provider entity will provide the training courses required to standardize the performance level of mediators to a uniform benchmark allowing the public to gain confidence and awareness of the value and processes.

A person wanting to learn more about the features and benefits of the mediation process can gather this information on the website.

A person with a dispute can register and log on to the website to initiate a resolution request by filling in an “Invitation to Mediate” form on the website that includes:
The parties contact information (email address and at minimum mailing address)
A brief description of the dispute using a drop down menu as the specifics are not necessary to be included
The preferred meeting method (via online webcam or face-to-face)
A method of immediate payment for the invitation fee and the refundable mediation fee
Identification of available dates and sessions over a 2 week period
Acceptance of standard terms and conditions
A copy of rules and regulations,
Rules of conduct
Fee schedule for extended session
Late and no-show policies

This will generate an automated invitation letter that will be sent to the opposite party via email (when address is provided) and by courier/FedEx to the mailing address.

The letter will inform the invited party as to:
The inviter's name
Indication of the invitation fee paid by the Inviter
Indication of the deposit made by the Inviter
Calendar revealing sessions over a two week period the Inviter is available
The brief description of the dispute
The ADR provider entity website information that will describe the mediation process
An outline of the steps required to accept or decline the invitation
The ADR provider entity web links to the site where a response can be input

If accepted, the ADR provider entity website will allow register, log-on and the move forward prompts
Immediate payment of the other one-half of the mediation fee
An availability calendar ranging from preferably 3 weeks to 5 weeks out from which the Invitee selects the date and session when the mediation is to be held
Acceptance of the meeting method offered by the Inviter or, if web-cam or in-person where both offered, then selection of the meeting method
Acceptance of standard terms and conditions
A copy of rules and regulations
Rules of conduct
Fee schedule for extended session
Late and no-show policies

If declined, the ADR provider entity website will allow register, log on and the move forward prompts
Acceptance of standard terms and conditions
Acceptance or rejection of the invitation
Optional reply to inviter using standard choices (no narrative allowed)

The response from the Invitee is channeled through the ADR provider entity and forwarded to the Inviter via email.

If declined, the inviter receives the mediation deposit credited back.

Once the date for the mediation and the venue are established, the ADR provider entity will select the appropriate mediator for the dispute, an email confirmation letter will be sent to both parties setting forth:
The chosen venue and date and time of mediation
Physical venue directions and FAQs or web criteria and FAQs.
A bio of the mediator
Request for copies of all submittals and evidence to be considered
A copy of the standard terms and conditions
A copy of rules and regulations, Rules of conduct
Fee schedule for extended session
Late and no-show policies
FAQs
technical assistance

Both parties have already or will be prompted again to accept all conditions and requirements as outlined above.

The session occurs via the meeting method, extended sessions as required. The mediator at the end of the required session(s) draws up the agreement or reports an impasse was declared (no agreement).

In the case of an online mediation, the mediator sends the agreement to both parties via email, the parties agree and reply using email signatures, the agreements are emailed to both parties and a copy is archived at the ADR provider entity. An optional service would capture the agreement on AV for archival.

In the case of a face-to-face mediation, the mediator draws up the agreement, both parties agree and sign, the agreements are given to both parties and a copy is archived at the ADR provider entity.

The mediator's submission of the session's agreement to the ADR provider entity via email or scanned document via email will prompt the ADR provider entity to email both disputing parties to confirm the session's agreement and offer a customer survey.

The confirming response from both parties prompts the payment to the mediator and the archiving of the agreement.

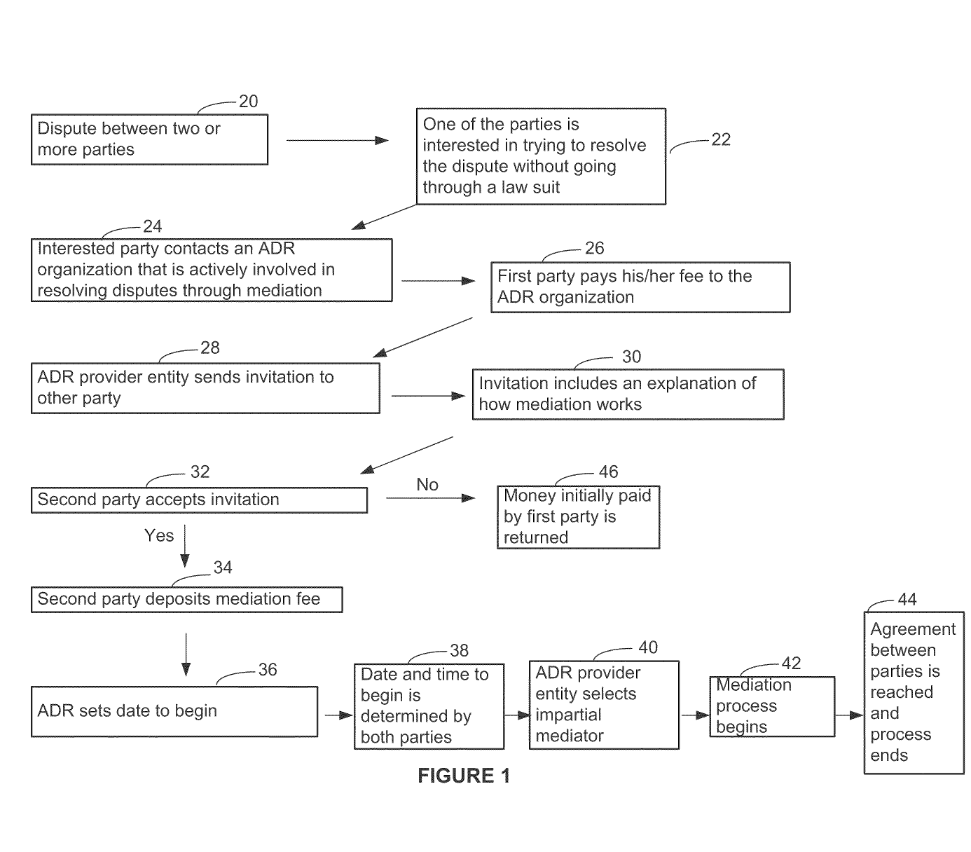

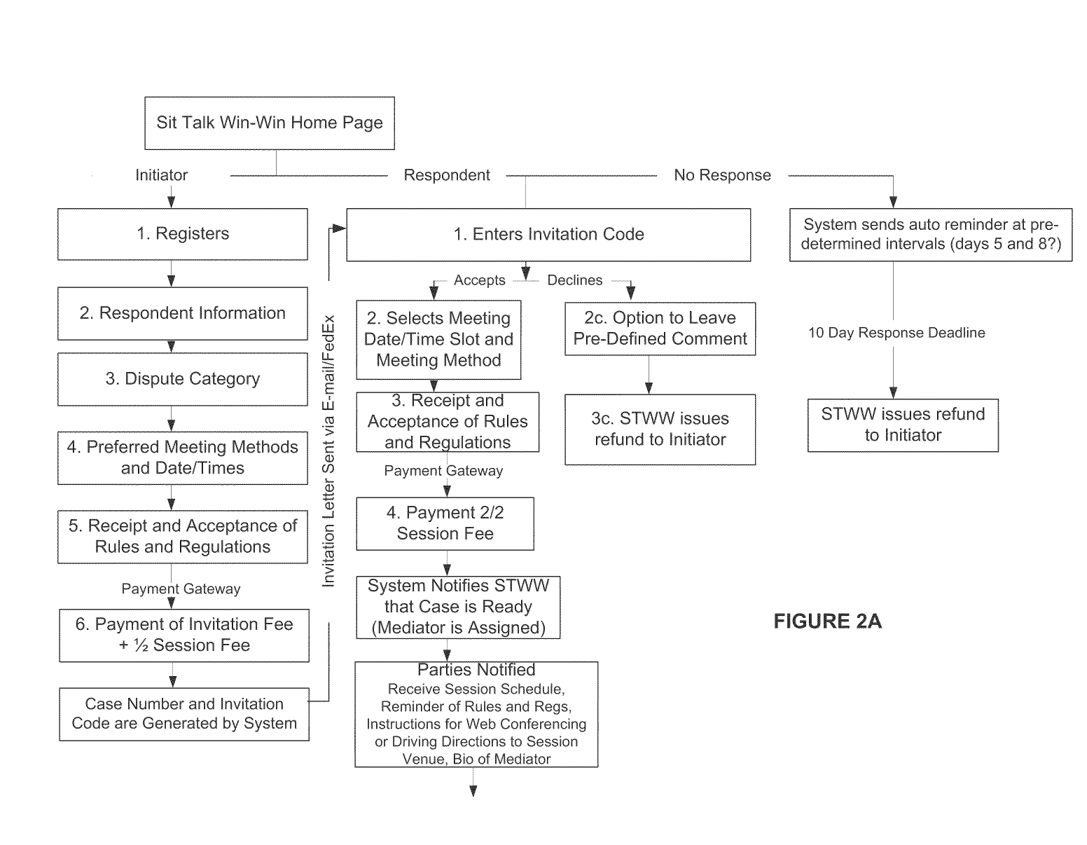

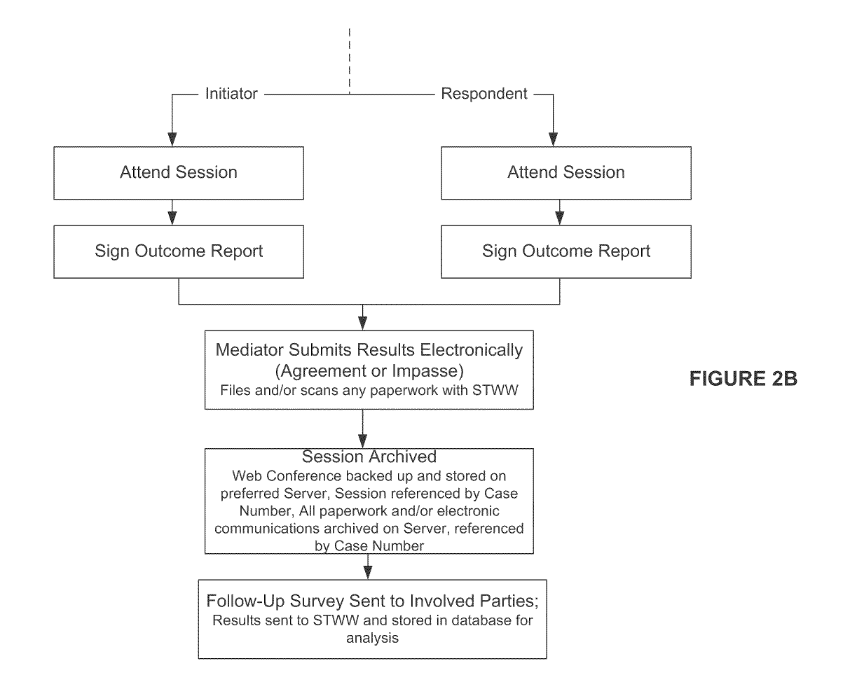

Referring to FIG. 1 and FIG. 2 there is shown a flow diagram of the method of the invention. At some time a dispute between two or more parties occurs, block 20. The dispute can be about the payment of a debt, ownership of an item, a property line location an easement right, performance of a contract, etc. Rather that immediately seeing a lawyer and proceeding with a law suit, one of the parties expresses an interest in trying to resolve the various issues of the dispute without going through the costly and time consuming process of a law suit, block 22. The party that is interested in trying mediation, hereinafter referred to as the first party or inviter, instead of seeing a lawyer and starting a law suit, contacts an ADR provider entity that is actively involved in setting up and resolving disputes between parties through mediation, block 24. The first party pays the required fees to the ADR provider entity, block 26. The ADR entity sends out an invitation to the other party in the dispute, preferably by email with an offer to help act as an impartial third party to mediate the dispute between the parties, block 28. The invitation includes an explanation of how mediation works, block 30. It explains that it is an alternative to lawyers and a court room where a judge or a jury decides the fate and outcome, that the process can take from six months to a couple of years at a cost of $3000 to $30,000 or more depending on the nature and size of the dispute. The invitation also explains that the time table for a resolution when both parties agree to mediation can be achieved as soon as the parties convene and, with the assistance of a mediator, an agreement can be obtained that is more than an “I win, you lose”, but will most likely be—we both win a little and lose a little—, and the neutrality of the impartial professional mediator, who is there to facilitate the discussion and negotiations and to guide the parties toward a final resolution. If the recipient (hereinafter the second party or invitee) of the invitation agrees to accept, YES, block 32, the second party goes to the web site and deposits his/her mediation fee, block 34. The ADR organization now schedules a date for mediation to begin, block 36. The date and time to begin is determined by both parties, block 38, and is based on the calendar of sessions that are available over the next three to five weeks. Unlike traditional professional services, the mediation sessions can be scheduled for three times each day, morning, afternoon and evening, six days each week and even two times, afternoon and evening, on Sunday.

This flexible schedule is important because Monday through Friday, nine to three, the traditional court time is not convenient and, therefore, is costly to a person who is working. Parties to a dispute will feel less put out and will be more receptive to arriving at a resolution when the mediation is held when it does not require time off from work or away from their business. In addition, mediators are more than willing to work evenings, Saturdays and Sundays when being paid in the area of $150 per hour. Convenience is enhanced with the use of web cameras and video conferencing. In addition, traffic, travel and parking concerns are greatly diminished, and security at court houses or at airports do not present a problem or detract form the process. Because access to the place of meeting is convenient, access to files and to personnel who may get involved in helping to resolve the problem is now possible, and a positive atmosphere brings a win-win attitude to the meeting.

With the use of translators and multi-lingual mediators from the beginning, addressing and resolving disputes between and among those whose language and culture barriers might have contributed to helping to resolve the dispute becomes necessary.

After the place and time is selected, the ADR provider entity selects an impartial mediator, block 40; and the mediating process begins, block 40, with the parties in the same room or in separate rooms. At some time thereafter the parties agree on a settlement and the process ends, block 44. Referring to block 32, if the second party refuses the invitation, the first party is notified and all money that he/she initially provided is returned, block 46.

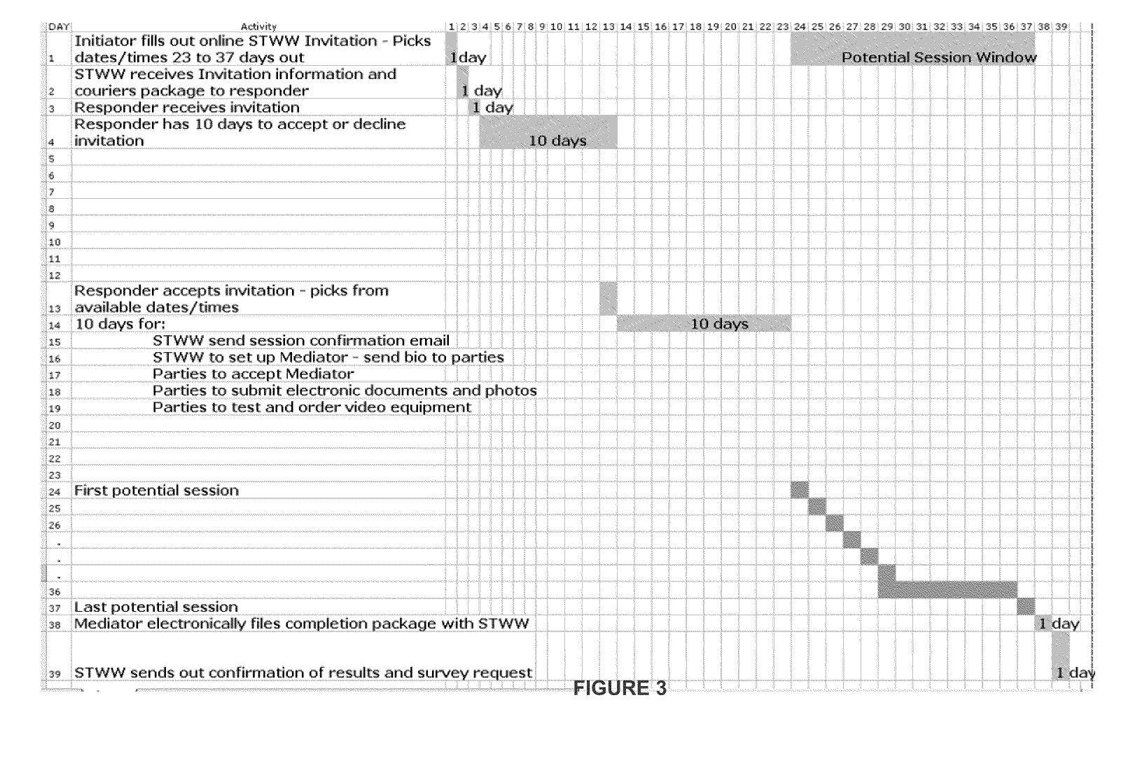

Now referring to FIG. 3, there is shown a preferred timeline of the above referenced system. The timelines for the herein described preferred embodiment may be varied in alternate embodiments. While there have been shown and described and pointed out the fundamental novel features of the invention as applied to the preferred embodiments, it will be understood that various omissions and substitutions and changes of the form and details of the apparatus illustrated and in the operation may be done by those skilled in the art, without departing from the spirit of the invention.

What is claimed is:

1. A method of performing an alternate dispute resolution procedure comprising the steps of:
providing an alternate dispute entity that is a scheduling service, facilitator and provider of mediation and/or arbitration services;
receiving from an inviter a request to initiate a mediation or arbitration procedure with an opposing party who has not been informed by said inviter of his/her decision to mediate or arbitrate;
extending an invitation to mediate or arbitrator from said entity to said opposing party, an invitee; wherein said invitee has the option of accepting or declining the invitation;
selecting a mediator from a pool of mediators after the invitee notifies the entity that the invitation is accepted; and
conducting the mediation via webcam on the entities website or at a location selected by said inviter and invitee.

2. The method of claim 1 wherein said invitation explains the process of mediation and that it is an alternative to a lawsuit.

3. The method of claim 1 wherein an inviter with a dispute can initiate a mediation or arbitration procedure by filling in an Invitation to Mediate form on a website of the entity.

4. The method of claim 3 wherein, subsequent to the inviter filing the Invitation to Mediate, an automated invitation letter is generated for transmission to the opposing party.

5. The method of claim 1 wherein said inviter deposits an invitation fee that is returned in the event the invitee declines to accept the invitation.

6. The method of claim 3 wherein said invitation to mediate form filled in by said inviter includes at least some of the following,
the parties contact information (email address and at minimum mailing address),
a brief description of the dispute using a drop down menu as the specifics are not necessary to be included,
the preferred meeting method (via online webcam or face-to-face),
a method of immediate payment for the invitation fee and the refundable mediation fee,
acceptance of standard terms and conditions,
a copy of rules and regulations,
Rules of conduct,
fee schedule for extended session,
late and no-show policies.

7. The method of claim 4 wherein said automated invitation letter generated for transmission to the opposing party includes at least some of the following, the inviter's name,
indication of the invitation fee paid by the Inviter,
indication of the deposit made by the Inviter,
calendar revealing sessions over a two week period the Inviter is available,
the brief description of the dispute,
the ADR provider entity website information that will describe the mediation process,
an outline of the steps required to accept or decline the invitation,
the ADR provider entity web links to the site where a response can be input.

8. The method of claim 7 wherein, if the invitation is accepted the entities website will allow the invitee to register, log-on and move forward prompts of at least some of the following,
immediate payment of the other one-half of the mediation fee,
an availability calendar ranging from 3 weeks to five weeks out from which the Invitee selects the date and session when the mediation is to be held,
acceptance of the meeting method offered by the Inviter or, if web-cam or in-person where both offered, then selection of the meeting method,
acceptance of standard terms and conditions,
a copy of rules and regulations,
rules of conduct,
fee schedule for extended session,
late and no-show policies.

9. The method of claim 7 wherein, if the invitation is declined the entities website will allow register, log-on and move forward prompts of at least some of the following,
acceptance of standard terms and conditions
acceptance or rejection of the invitation
optional reply to inviter using standard choices absent any narrative.

10. The method of claim 1 wherein after the invitee has accepted and a date for the mediation and a venue is established, the entity selects the appropriate mediator for the dispute and an email confirmation letter is sent to both parties setting forth at least some of the following,
the chosen venue and date and time of mediation,
physical venue directions and FAQs or web criteria and FAQs,
a bio of the mediator,
request for copies of all submittals and evidence to be considered,
a copy of the standard terms and conditions,
a copy of rules and regulations, Rules of conduct,
fee schedule for extended session,
late and no-show policies,
FAQs.

11. A system for performing an alternate dispute resolution procedure comprising the steps of:
providing an alternate dispute entity that is a scheduling service, facilitator and provider of mediation and/or arbitration services;
receiving from an inviter a request to initiate a mediation or arbitration procedure with an opposing party who has not been informed by said inviter of his/her decision to mediate or arbitrate;
extending an invitation to mediate or arbitrator from said entity to said opposing party, an invitee; wherein said invitee has the option of accepting or declining the invitation;
selecting a mediator from a pool of mediators after the invitee notifies the entity that the invitation is accepted; and
conducting the mediation via webcam on the entities website or at a location selected by said inviter and invitee.

12. The system of claim 11 wherein said invitation explains the process of mediation and that it is an alternative to a lawsuit.

13. The system of claim 11 wherein an inviter with a dispute can initiate a mediation or arbitration procedure by filling in an Invitation to Mediate form on a website of the entity.

14. The system of claim 33 wherein, subsequent to the inviter filing the Invitation to Mediate, an automated invitation letter is generated for transmission to the opposing party.

15. The system of claim 11 wherein said inviter deposits an invitation fee that is returned in the event the invitee declines to accept the invitation.

16. The system of claim 13 wherein said invitation to mediate form filled in by said inviter includes at least some of the following,
the parties contact information (email address and at minimum mailing address),
a brief description of the dispute using a drop down menu as the specifics are not necessary to be included,
the preferred meeting method (via online webcam or face-to-face),
a method of immediate payment for the invitation fee and the refundable mediation fee,
identification of available dates and sessions over a two week period,
acceptance of standard terms and conditions,
a copy of rules and regulations,
rules of conduct,
fee schedule for extended session,
late and no-show policies.

17. The system of claim 14 wherein said automated invitation letter generated for transmission to the opposing party includes at least some of the following,
the inviter's name,
indication of the invitation fee paid by the Inviter,
indication of the deposit made by the Inviter,
calendar revealing sessions over a two week period the Inviter is available,
the brief description of the dispute,
the ADR provider entity website information that will describe the mediation process,
an outline of the steps required to accept or decline the invitation,
the ADR provider entity web links to the site where a response can be input.

18. The system of claim 17 wherein, if the invitation is accepted the entities website will allow the invitee to register, log-on and move forward prompts of at least some of the following,
immediate payment of the other one-half of the mediation fee,
an availability calendar ranging from 3 weeks to 5 weeks out from which the Invitee selects the date and session when the mediation is to be held,
acceptance of the meeting method offered by the Inviter or, if web-cam or in-person where both offered, then selection of the meeting method,
acceptance of standard terms and conditions,
a copy of rules and regulations,
rules of conduct,
fee schedule for extended session,
late and no-show policies.

19. The system of claim 17 wherein, if the invitation is declined the entities website will allow register, log-on and move forward prompts of at least some of the following,
acceptance of standard terms and conditions,
acceptance or rejection of the invitation,
optional reply to inviter using standard choices absent any narrative.

20. The system of claim 11 wherein after the invitee has accepted and a date for the mediation and a venue is established, the entity selects the appropriate mediator for the dispute and an email confirmation letter is sent to both parties setting forth at least some of the following,
the chosen venue and date and time of mediation,
physical venue directions and FAQs or web criteria and FAQs,
a bio of the mediator,
request for copies of all submittals and evidence to be considered,
a copy of the standard terms and conditions,
a copy of rules and regulations, Rules of conduct,
fee schedule for extended session,
late and no-show policies,
FAQs.
